(19) United States
(12) Patent Application Publication
(10) Pub. No.: US 2012/0085631 A1
(43) Pub. Date: Apr. 12, 2012

(54) Waterproof Structure for Press Switch of Flashlight

(76) Inventor: Ching-Hsiang Wang, Tainan City (TW)

(21) Appl. No.: 12/899,657

(22) Filed: Oct. 7, 2010

(51) Int. Cl. H01H 13/06

(52) U.S. Cl. 200/302.2

(57) ABSTRACT

A waterproof structure for a press switch of a flashlight is disclosed. The flashlight to be used in water or high-moisture environments has a flashlight body formed as a whole by using a rigid plastic material and the press switch integratedly formed, by using a non-rigid plastic material, about a border between a lighting segment and a handle segment of the flashlight body, so that the press switch combined with the flashlight body as an integrated member is able to form a circuit between conductive contacts inside the flashlight body and batteries assembled between the conductive contacts or break the circuit, so as to turn on or off a light bulb of the flashlight, without the concern that external rainwater or moisture may intrude into the flashlight.

### BACKGROUND OF THE INVENTION

1. Technical Field

The present invention relates to a waterproof structure for a press switch of a flashlight. More particularly, the press switch is one provided to a flashlight that is suitable for illumination in occasions of diving, mining pits, in-rain rescue, and so on, and the waterproof structure is integratedly formed with a flashlight body about a border between a lighting segment and a handle segment of the flashlight body, so that in use of the flashlight, external water can be prevented from permeating into the internal of the flashlight.

2. Description of Related Art

In order to cater for various applications, the existing flashlights are designed by the pertinent manufacturers with diverse forms, which are constructed from different assembly configurations. The related art referred by the present invention are flashlights to be used in occasions of diving, mining pits, in-rain rescue, firemen's rescuing trapped people in the scenes of fires, and so on. A flashlight for these purposes must have a flashlight body, as such, formed with the capabilities of enduring elevated temperature and preventing external moisture from intruding thereinto. According to the prior art, the flashlight has a press switch assembled at a periphery of a front end of the flashlight body of a predetermined shape. The press switch serves to control conductive contacts provided inside the flashlight to form a circuit with batteries installed between the contacts or break such a circuit. The press switch is a separate component typically made in advance through an injection molding process, and then settled in a socket preformed on the flashlight body, so as to act as a switch that turns on or off a light bulb of the flashlight.

As mentioned above, the press switch is separately formed and then assembled to the flashlight, so it tends to allow external water to permeate into the flashlight via interstices between the assembled press switch and flashlight after the flashlight is used in a heavy rain or is used for a certain term of time. Consequently, once the permeating water damages the components, the conductive contacts and batteries inside the flashlight may not normally work to lighten the flashlight.

### SUMMARY OF THE INVENTION

The present invention is made to improve the shortcomings of the existing flashlights for special purposes by making a flashlight have a press switch integratedly formed at a predetermined portion of its flashlight body to turn on or off a light bulb of the flashlight, so that external rainwater and/or moisture can be prevented from intruding into the flashlight.

The primary of the present invention is to provide the waterproof structure applicable a flashlight to be used in water or high-moisture environments. The flashlight has a flashlight body formed as a whole by using a rigid plastic material and the press switch integratedly formed, by using a non-rigid plastic material, about a border between a lighting segment and a handle segment of the flashlight body, so that the press switch combined with the flashlight body as an integrated member is able to form a circuit between conductive contacts inside the flashlight body and batteries assembled between the conductive contacts or break the circuit, so as to turn on or off a light bulb of the flashlight, without the concern that external rainwater or moisture may intrude into the flashlight.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a flashlight with a press switch at one end thereof according to the present invention;

FIG. 2 is a lateral of the flashlight of FIG. 1; and

FIG. 3 is an enlarged cross-sectional view of the press switch at the end of the flashlight according to the present invention.

### DETAILED DESCRIPTION OF THE INVENTION

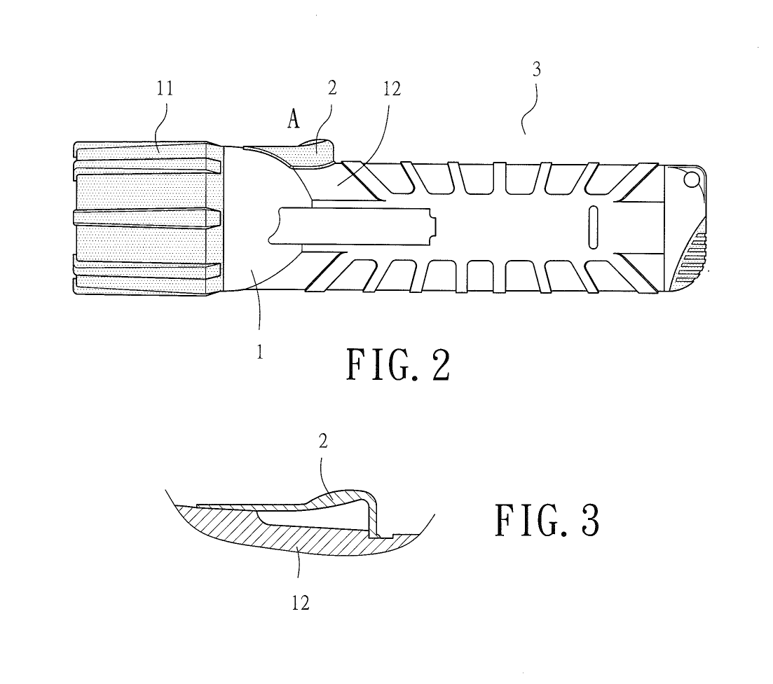

Referring to FIG. 2, as provided by the present invention, a waterproof structure for a press switch of a flashlight is applied to a flashlight (3) to be used in water or high-moisture environments. The flashlight (3) is composed of a flashlight body (1) and a press switch (2) for turning on or off a light bulb of the flashlight (3).

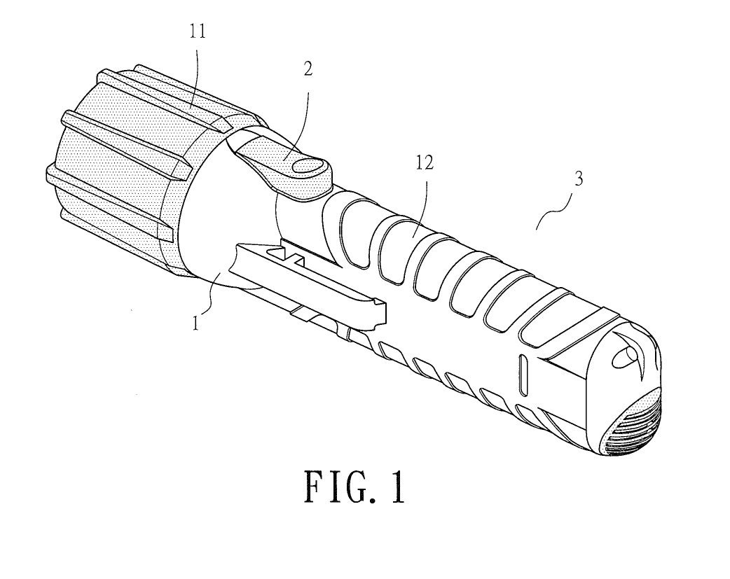

The flashlight (3) has a flashlight body (1) formed as a whole by using a rigid plastic material (as shown in FIG. 2) and the press switch (2) integratedly formed, by using a non-rigid plastic material, about a border between a lighting segment (11) and a handle segment (12) of the flashlight body (as shown in FIG. 3), so that the press switch (2) combined with the flashlight body (1) as an integrated member (as shown in FIG. 1) is able to form a circuit between conductive contacts inside the flashlight body (1) and batteries assembled between the conductive contacts or break the circuit, so as to turn on or off a light bulb of the flashlight. Thereby, the waterproof structure can effectively prevent external rainwater and/or moisture from intruding into the flashlight (3) and in turn eliminates the concern that the flashlight (3) may be affected by external moisture after a certain term of use to become failed and unusable.

What is claimed is:

1. A waterproof structure for a press switch of a flashlight, being characterized in:
the flashlight having a flashlight body formed as a whole by using a rigid plastic material and the press switch integratedly formed, by using a non-rigid plastic material, about a border between a lighting segment and a handle segment of the flashlight body, so that the press switch combined with the flashlight body as an integrated member is able to form a circuit between conductive contacts inside the flashlight body and batteries assembled between the conductive contacts or break the circuit, so as to turn on or off a light bulb of the flashlight that is to be used in water or high-moisture environments, thereby preventing external rainwater or moisture from intruding into the flashlight.
